(19) United States
(12) Patent Application Publication
(10) Pub. No.: US 2017/0220792 A1
(43) Pub. Date: Aug. 3, 2017

(54) CONSTRAINING AUTHORIZATION TOKENS VIA FILTERING

(71) Applicant: HEWLETT PACKARD ENTERPRISE DEVELOPMENT LP, Houston, TX (US)

(72) Inventors: Andrew REA, Warrington (GB); Marc D. STIEGLER, Palo Alto, CA (US)

(73) Assignee: HEWLETT-PACKARD DEVELOPMENT COMPANY, L.P., Houston, TX (US)

(21) Appl. No.: 15/328,350

(22) PCT Filed: Jul. 25, 2014
(86) PCT No.: PCT/US2014/048228

§ 371 Date: Jan. 23, 2017

(51) Int. Cl. G06F 21/45; G06F 21/31; G06F 17/30

(52) U.S. Cl. CPC G06F 21/45; G06F 17/30327; G06F 21/31; G06F 2221/2145

(57) ABSTRACT

Constraining authorization tokens via filtering in one example implementation can include generating a first authorization token that provides a first level of access to first data matching a first set of criteria. A filter can be applied to constrain a second authorization token that provides a second level of access to second data matching a second set of criteria. The first authorization token and the second authorization token can have a subset relationship where the first level of access is greater than the second level of access, and the relationship between the first and second authorization token can be maintained.

### BACKGROUND

Information can be protected by controlling access through authorizations; however, authorizations may be broad or narrow.

### BRIEF DESCRIPTION OF THE DRAWINGS

FIG. 1 illustrates a diagram of an example of a system according to the present disclosure.

FIG. 2 illustrates a diagram of an example computing device according to the present disclosure.

FIG. 3 illustrates a flow diagram of an example of token delegation according to the present disclosure.

FIG. 4 illustrates a flow diagram of an example of cascading token revocation according to the present disclosure.

FIG. 5 illustrates a flow diagram of an example of token revocation according to the present disclosure.

FIG. 6 illustrates a flow diagram of an example of token attribute evaluation according to the present disclosure.

FIG. 7 illustrates a flow diagram of an example of token attribute evaluation according to the present disclosure.

FIG. 8 illustrates a flow diagram of an example of token delegation according to the present disclosure.

FIG. 9 illustrates a flow diagram of an example token of delegation according to the present disclosure.

FIG. 10 illustrates a flow diagram for an example method for token delegation and revocation according to the present disclosure.

FIG. 11 illustrates a diagram of an example system including a processor and non-transitory computer readable medium according to the present disclosure.

### DETAILED DESCRIPTION

A goal in best security practices is to achieve a “least privilege” of access rights, in which each user receives all the access rights that they need—but no more. However, providing appropriate (i.e., neither over-provisioned nor under-provisioned) access rights can be difficult due to a number of factors. For example, coarse-grained access policies, such as the commonly implemented role-based access control (RBAC), can lead to security vulnerabilities due to a lack of fine-grained access control. On the other hand, more finely-grained access control policies such as attribute based access control (ABAC) and risk adaptive access control (RADAC), which grant access rights based on combinations of attributes of a user, suffer from inconsistent definitions of attributes across organizations, and are often susceptible to attribute alteration in the case where a user's attributes are unspecified. Moreover, the above policies for specifying access rights each rely on authentication in the local accessed system context and have no native implementation of cross-domain access control.

In addition to the above described difficulties, delegating access rights to disparate users may over-provision and/or under-provision disparate users. For example, this may cause security issues in the case of an over-provisioned user who has access rights they do not need and/or productivity issues for an under-provisioned user that does not have requisite access rights to perform their tasks.

Examples of the present disclosure include methods, systems, and computer-readable and executable instructions for generating authorization tokens via filtering. Advantageously, constraining authorization tokens via filtering can provide access control that is neither over-provisioned nor under-provisioned. Examples implement access control using authorization based access control (ZBAC) to facilitate an authorization token system where fine-grained access control can be delegated from a coarse-grained policy in an existing enterprise system.

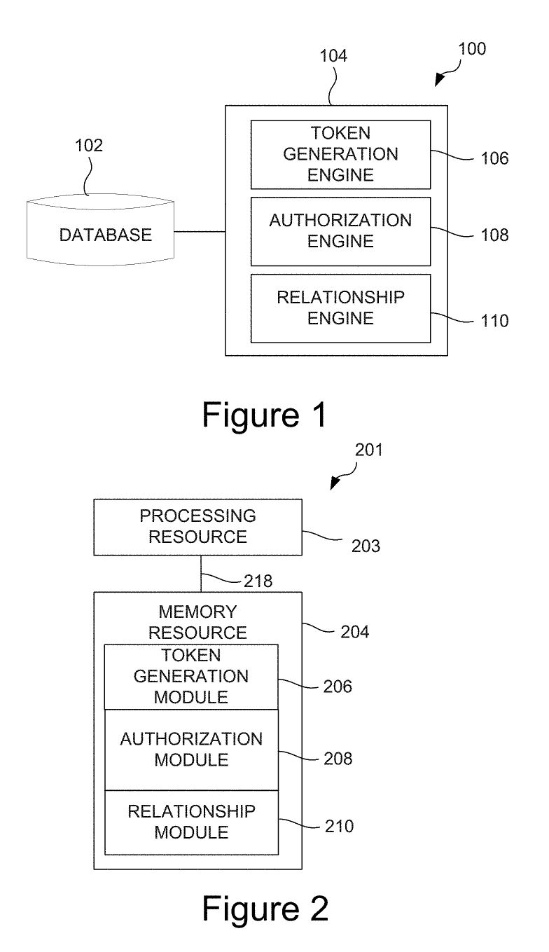

FIG. 1 illustrates a diagram of an example of a system according to the present disclosure. As shown in the example of FIG. 1, the system 100 can include a database 102 accessible by and in communication with a plurality of engines 104. The engines 104 can include a token generation engine 106, an authorization engine 108, and a relationship engine 110, etc. The system 100 can include additional or fewer engines than illustrated to perform the various functions described herein and embodiments are not limited to the example shown in FIG. 1. The system 100 can include hardware, e.g., in the form of transistor logic and/or application specific integrated circuitry (ASICs), firmware, and software, e.g., in the form of machine readable and executable instructions (program instructions (programming) stored in a machine readable medium (MRM)) which in cooperation can form a computing device as discussed in connection with FIG. 2.

The plurality of engines can include a combination of hardware and software, e.g., program instructions, but at least includes hardware that is configured to perform particular functions, tasks and/or actions. For example, the engines shown in FIG. 1 can be used to delegate fine-grained access authorizations from a coarse-grained policy by generating a first authorization token that provides a first level of access to first data matching a first set of criteria, applying a filter to constrain a second authorization token that provides a second level of access to second data matching a second set of criteria, where the first authorization token and the second authorization token have a subset relationship where the first level of access is greater than the second level of access, and maintaining the relationship between the first and second tokens. As used herein, a “subset relationship” is a relationship where the set of access rights of a token are contained in the set of access rights of another token. For example, if token “A” has access rights “1, 2, 3” and token “B” has access rights “1, 2”, then the access rights of token “B” have a subset relationship to the access rights of token “A”.

As used herein, “delegate” and “delegation” are the generation of an authorization token having a certain set of access rights. For example, an authorization token that provides a level of access to data matching a set of criteria.

For example, the token generation engine 106 can include hardware and/or a combination of hardware and program instructions to generate a first authorization token having a respective first secret and granting full access to a plurality of existing objects in an existing enterprise, and constrain a second authorization token having a respective second secret, wherein the second authorization token grants comparatively less access to the plurality of existing objects in the existing enterprise than the first authorization token. In some examples, constraining the second authorization token can include applying a filter to delegate the permissions associated with the second authorization token. In addition, in some examples, the second token is constrained through a filter that is specified upon delegation. As used herein, “generating” is the creation of a new authorization token that did not exist prior to being generated. As used herein, “constraining” is the delegation of an authorization token via a filter.

As used herein, a “token” is an authorization security device that can be used to control access rights to computer services. In some examples, a token can be software based (e.g., a two-factor authorization, digital certificate, un-guessable string, etc.) and each token can implicitly specify the set of rights it authorizes. For example, one token may authorize reading and writing a particular file, while a different token may authorize reading (e.g., only reading) that file.

As used herein, a “filter” is the specification of a desired subset of access rights associated with the first authorization token. For example, a first token can have permissions associated with a certain amount of access to a system (e.g., the ability to read and write to all files in the system). A request to delegate a second token that can, for example, read all files in the system (but not write to them) can include filtering the permissions of the first token to yield a second token with the requested attributes. In this regard, a plurality of subsequent authorization tokens, each having an attenuated set of access rights can be generated. Further, as used herein, “applying a filter” is the process of implementing the filter to constrain an authorization token having a subset of the access rights associated with an existing authorization token.

The authorization engine 108 can include hardware and/or a combination of hardware and program instructions to associate the first secret to a first authorization policy and/or can associate the second secret to a second authorization policy. In addition, the authorization engine 108 can associate the first secret and first authorization policy to the first authorization token and/or can associate the second secret and second authorization policy to the second authorization token. In some examples, the first secret and the second secret are different (e.g., not the same). As used herein, a “secret” is an index to a ZBAC authorization token (ZAT) store that maintains authorization permissions with corresponding respective tokens. For example, an entry in the ZAT store can map a secret, (e.g., the secret “39gq”) to the permission to read and write to a particular file. Similarly, an entry in the ZAT store can map another secret, (e.g., the secret “les9”) to the permission to only read the same file. In this regard, any write request for the file accompanied by the secret “les9” can be rejected while a read request accompanied by the secret “les9” can be granted. In some examples, the first secret and second secret can be maintained in a ZAT store. As used herein, “map” and “mapping” are the association of an element in one set (e.g., a secret) with one or more elements of a second set (e.g., an authorization policy specifying access rights).

The relationship engine 110 can include hardware and/or hardware and program instructions to maintain a hierarchal relationship including a parent-child relationship between the first authorization token and the second authorization token. That is, the relationship engine 110 can create or otherwise obtain a hierarchal relationship between the first authorization token and the second authorization token that can be maintained. For example, the hierarchal relationship can be a parent-child relationship with the first authorization token functioning as the parent, and the second authorization token, possessing comparatively less access than the first authorization token, functioning as the child. In addition, in some examples, the parent-child relationship between tokens is transparent in only one direction, for example, the parent token can see its offspring tokens, but the offspring tokens are not aware of their respective associated parent tokens.

Embodiments are not limited to the example engines shown in FIG. 1 and one or more engines described may be combined or may be a sub-engine of another engine. Further, the engines shown may be remote from one another in a distributed computing environment, cloud computing environment, etc.

FIG. 2 illustrates a diagram of an example computing device according to the present disclosure. The computing device 201 can utilize hardware, software (e.g., program instructions), firmware, and/or logic to perform a number of functions described herein. The computing device 201 can be any combination of hardware and program instructions configured to share information. The hardware can, for example, include a processing resource 203 and a memory resource 204 (e.g., computer or machine readable medium (CRM/MRM), database, etc.). A processing resource 203, as used herein, can include one or more processors capable of executing instructions stored by the memory resource 204. The processing resource 203 may be implemented in a single device or distributed across multiple devices. The program instructions (e.g., computer or machine readable instructions (CRI/MRI)) can include instructions stored on the memory resource 204 and executable by the processing resource 203 to perform a particular function, task and/or action (e.g. provide a first authorization token, etc.).

The memory resource 204 can be a non-transitory machine readable medium, include one or more memory components capable of storing instructions that can be executed by a processing resource 203, and may be integrated in a single device or distributed across multiple devices. Further, memory resource 204 may be fully or partially integrated in the same device as processing resource 203 or it may be separate but accessible to that device and processing resource 203. Thus, it is noted that the computing device 201 may be implemented on a participant device, on a server device, on a collection of server devices, and/or a combination of a participant, (e.g., user/consumer endpoint device), and one or more server devices as part of a distributed computing environment, cloud computing environment, etc.

The memory resource 204 can be in communication with the processing resource 203 via a communication link (e.g., a path) 218. The communication link 218 can provide a wired and/or wireless connection between the processing resource 203 and the memory resource 204.

In the example of FIG. 2, the memory resource 204 includes a token generation module 206, an authorization module 208, and a relationship module 210. As used herein a module can include hardware and software (e.g., program instructions), but includes at software that can be executed by a processing resource, for example, processing resource 203, to perform a particular task, function and/or action. The plurality of modules may be combined or may be sub-modules of other modules. As shown in FIG. 2, the token generation module 206, the authorization module 208, and the relationship module 210 can be individual modules located on one memory resource 204. Embodiments are not so limited, however, and a plurality of modules can be located at separate and distinct memory resource locations, for example, in a distributed computing environment, cloud computing environment, etc.

Each of the plurality of modules can include instructions that when executed by the processing resource 203 can function as an engine such as the engines described in connection with FIG. 1. For example, the token generation module 206 can include instructions that when executed by the processing resource 203 can function as the token generation engine 106 shown in FIG. 1. The authorization module 208 can include instructions that when executed by the processing resource 203 can function as the authorization engine 108 shown in FIG. 1. Additionally, the relationship module 210 can include instructions that when executed by the processing resource 203 can function as the relationship engine 110 shown in FIG. 1.

Embodiments are not limited to the example modules shown in FIG. 2 and in some cases a number of modules can operate together to function as a particular engine. Further, the engines and/or modules of FIGS. 1 and 2 can be located in a single system and/or computing device or reside in separate distinct locations in a distributed network, cloud computing, enterprise service environment (e.g., Software as a Service (SaaS) environment), etc.

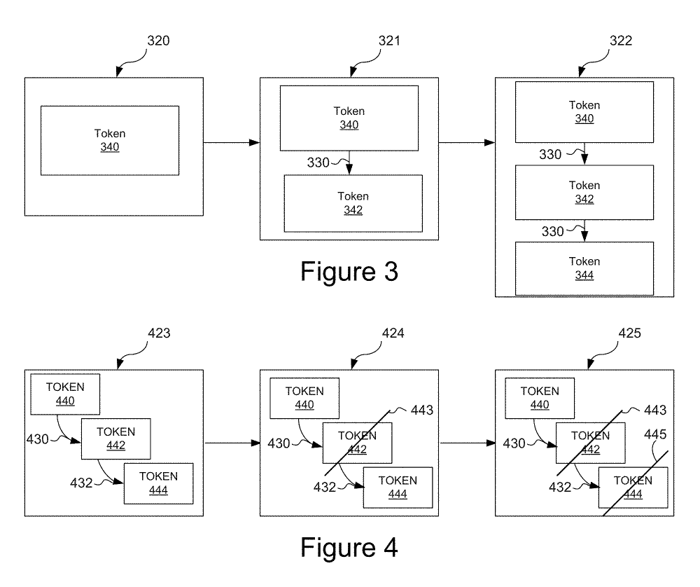

FIG. 3 illustrates a flow diagram of an example of token delegation according to the present disclosure. In some examples, at block 320 a first coarse-grained token (e.g., token 340) is provided. In the example of FIG. 3, token 340 can allow access to any user who knows the secret associated with token 340 for use in any geography 340. In some examples, a delegation request can be made at block 321 for a second token (e.g., token 342) to be generated. Upon delegation, a filter can be specified to generate the authorization, as indicated by the arrow 330. In the example of FIG. 3, token 342 can be delegated to any users who know the secret associated with a user group, (e.g., “alpha”) for use in any geography.

At 322, a third token, token 344 can be delegated to any users that know the secret associated with a user group “alpha” for use in a specific geography (e.g., Asia). As indicated by the arrows 330, after the filter is applied, the constrained tokens, for example, token 342 and token 344, are characterized by more fine-grained access control than their respective parent tokens. That is, token 340, which is the parent token to token 342, has a broader scope of access than its child, token 342. In addition, this hierarchal relationship can be one-directional. That is, in some examples, any child token can possess no more access rights than the parent token that delegated it. Further, the parent-child relationship can be configured such that the child token does not know that it is a child token and/or the child token cannot see the parent token.

In some examples, the secrets for each respective token can be maintained in a ZBAC authorization token (ZAT) store. For example, the ZAT store can maintain an index, (e.g., a ZAT table) that can match a secret with the authorization policies associated with that secret.

FIG. 4 illustrates a flow diagram of an example of cascading token revocation according to the present disclosure. In the example of FIG. 4, a cascading revocation of tokens, wherein the revocation of a parent token can result in the revocation of all its descendent tokens, is illustrated. In some examples, the parent delegation tree is “walked” to evaluate whether there are any revoked tokens in the chain. As used herein, “walking the delegation chain” means systematically and sequentially evaluating the attributes of each token in the delegation chain and/or checking to see if each respective token in the delegation chain is revoked (e.g., whether at least one token in the delegation chain is revoked).

For example, at block 423, three tokens—token 440, token 442, and token 444, can be provided. In the example of FIG. 4, token 444 is the child token to token 442 and token 440. Token 442 is the parent of token 444, as indicated by the arrow 432, and the child of token 440, as indicated by the arrow 430. Similarly, token 440 is the parent of token 442, as indicated by the arrow 430.

In some examples, at block 424, token 442 can be revoked, as indicated by the strike-through line 443. At 425, a user can then try to access information associated with token 444 after token 442 is revoked; however, because token 442 is the parent of token 444, token 444 can also be revoked as indicated by the strike-through line 445.

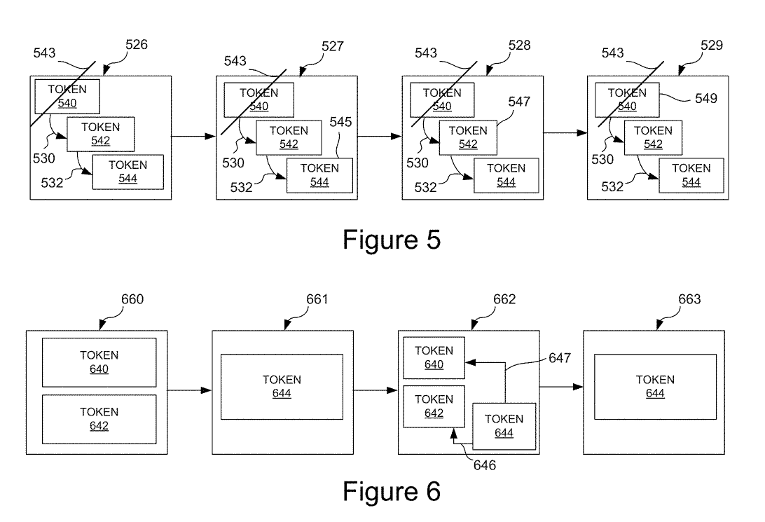

FIG. 5 illustrates a flow diagram of an example of token revocation according to the present disclosure. In the example of FIG. 5, the parent delegation chain is “walked” to evaluate whether a parent token in the parent delegation chain is revoked. Subsequent tokens up the chain (e.g., each subsequent parent token) can be checked in the same way and compared to the child tokens. In some examples, the parent-child relationship operates such that a child token is revoked in response to a parent token being revoked, for example, if a parent token is revoked, the children of that parent token can be revoked.

In the example of FIG. 5 at 526, token 540 can be a parent token of token 542, as indicated by the arrow 530, and token 542 can be a parent of token 544, as indicated by the arrow 532. At block 528, token 540 can be revoked as indicated by the strike-through line 543. At block 527, a user who possesses the secret associated with token 544 can attempt to access a system using token 544. In some examples, the system checks first to see if token 544 is revoked 545. If token 544 is not revoked, as in the example of FIG. 5, at block 528, the system can check to see if its parent token, token 542 in the example of FIG. 5, is revoked 547. At block 528, the system can check to see if token 540 is revoked 549. If token 540 is revoked, as in the example of FIG. 5, the system can revoke token 542 and token 544, for example at block 529.

FIG. 6 illustrates a flow diagram of an example of token attribute evaluation according to the present disclosure. In the example of FIG. 6, the parent delegation chain can be “walked” to evaluate whether the aggregate attributes of all the tokens in the parent delegation chain do not contain attribute mismatches, for example, where one attribute negates another attribute. For example, the delegation chain can be “walked” to evaluate whether the aggregate attributes of all the tokens in the chain do not contain mismatches, for example, where one or more attributes of a child token negate one or more attributes of a token higher up the chain. Subsequent tokens up the chain (e.g., each subsequent parent token) can be checked in the same way and compared to the child tokens. In some examples, if a mismatch is found in the attributes of the evaluated tokens, the children of that parent token can be revoked.

At block 660, a first token, token 640 and a child token to the first token, token 642, can be delegated. In some examples, token 640 can be authorized for use by users in the group “1,” and a child token 642 can be authorized for use by users in the group “2.”

At 661, a request can be made for a third token, token 644 to be delegated for use by users in the group “2.” In the example of FIG. 6, token 644 can be a child token to token 642, which is a child token to token 640.

At 662, the system can check the attributes of the parent tokens of token 644 to determine if token 644 is authorized or denied. In some examples, the system checks 646 the attributes of token 644 and token 642 to see if they match. For example, the system can check to see if token 642 and token 644 authorized for the same group of users. In the same way, the system can check 647 the attributes of token 644 and token 640 to see if they match, for example, token 640 and token 644 are authorized for the same groups of users.

In the example of FIG. 6 at block 663, token 644 is denied because parent token 640 and token 644 do not contain the same attributes, as shown at block 662, for example, token 640 and token 644 are authorized for different user groups.

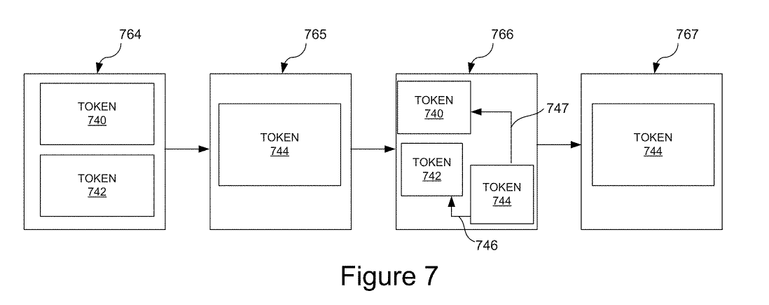

FIG. 7 illustrates a flow diagram of an example of token attribute evaluation according to the present disclosure. Similar to the example of FIG. 6, in the example of FIG. 7, the parent delegation chain can be “walked” to evaluate whether the aggregate attributes of all the tokens in the parent delegation chain do not contain attribute mismatches, for example, where one attribute negates another attribute. In some examples, the system can make a distinction between tokens based on the specificity of the token, i.e., in some examples a child token can be authorized to access the system because the child token contains attributes that are more specific than the attributes if the parent token.

At block 764, for example, a first token, token 740 can be authorized for any user. A second token, token 742 can be delegated and authorized for use by users in the user group “2.” At 765, a request can be made for a third token, token 744 to be delegated for use by users in the group “2.” In the example of FIG. 7, token 744 can be a child token to token 742, which is a child token to token 740.

At 766, the system can check the attributes of the parent tokens of token 744 to determine if token 744 is authorized or denied. In some examples, the system can check 746 the attributes of token 744 and token 742 to see if they match. For example, the system can check to see if token 742 and token 744 are authorized for the same group of users. In the same way, the system can check 747 the attributes of token 744 and token 740 to see if they match, for example, token 740 and token 744 are authorized for the same groups of users.

In the example of FIG. 7 at block 767, token 744 can be authorized because token 742 and token 744 are authorized for the same group of users and because parent token 740 is authorized for a group of users of which the user group authorized under token 744 is a subset, for example, token 740 is authorized for any user and token 744 is authorized for user group “2.”

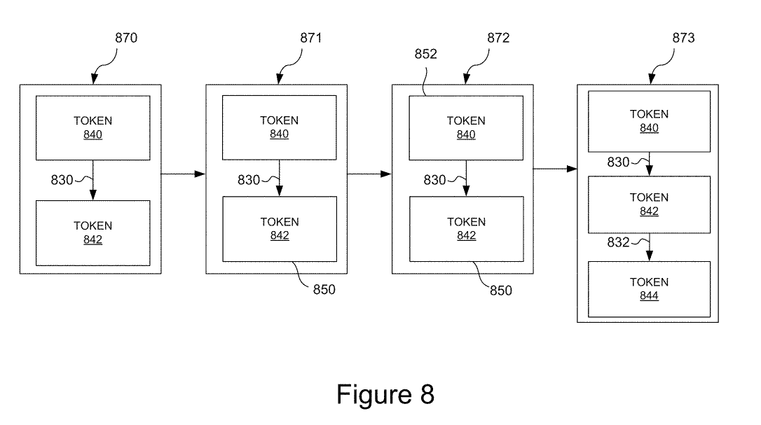

FIG. 8 illustrates a flow diagram of an example of token delegation according to the present disclosure. In the example of FIG. 8, the delegation tree can be walked at the time of delegation. For example, a delegation request can be received, and token 842 can be checked 850 to ensure the delegation is valid. If the delegation is valid, the parent token, token 840, can be checked 852 to ensure it is valid. In the example of FIG. 8, both the delegation and token 840 are valid, so the delegation can be authorized and token 844 can be generated.

In some examples, at block 870, an initial valid delegation can be made. Token 840 can be the parent token and token 842 can be the child token, as indicated by the arrow 830. In some examples, at 871, a delegation request can be received, and the system can check 850 token 842 to see if token 842 is revoked and/or has an attribute mismatch with its parent token, token 840. In the example of FIG. 8, token 842 has not been revoked so the system can proceed to check token 840 for revocation and/or mismatched attributes.

At block 872, the system can check 852 token 840 for revocation and/or mismatched attributes. In the example of FIG. 8, token 840 has not been revoked, and token 840 does not have mismatched attributes with token 842. In some examples, at block 873, the system can delegate a new token, token 846, which, as indicated by the arrow 832, is the child of token 842.

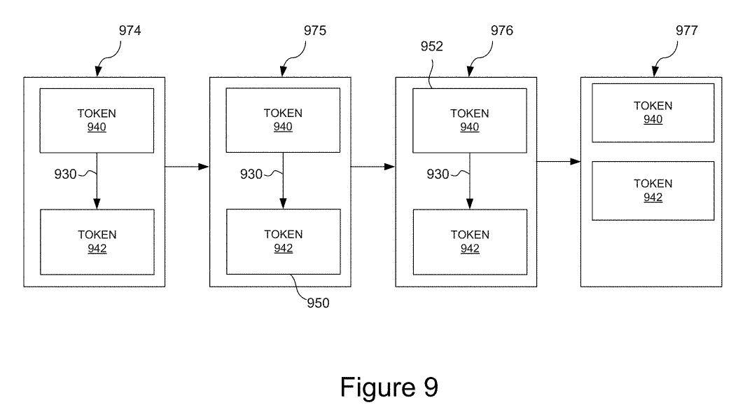

FIG. 9 illustrates a flow diagram of an example token of delegation according to the present disclosure. In the example of FIG. 9, the delegation tree can be walked at the time of delegation prior to a revocation cascading to a child token. For example, a parent token can be revoked before the execution has had time to cascade the revocation down to the child token. In some examples, the delegation tree can be walked to ensure the delegation is not authorized.

For example, at block 974, a valid delegation can be made where token 940 has not been revoked, and token 942, which is the child of token 974 as indicated by the arrow 930, has not been revoked. At 975, token 940 can be revoked and token 942 may not be revoked. In some examples, token 942 can be checked 950 to see if it is revoked. In the example of FIG. 9, token 942 has not been revoked, so token 940 can be checked. At 976, token 940 can be checked 952 to see if it is revoked. In the example of FIG. 9, token 940 is revoked, so a delegation request cannot be fulfilled. For example, at 977, a delegation request can be unauthorized.

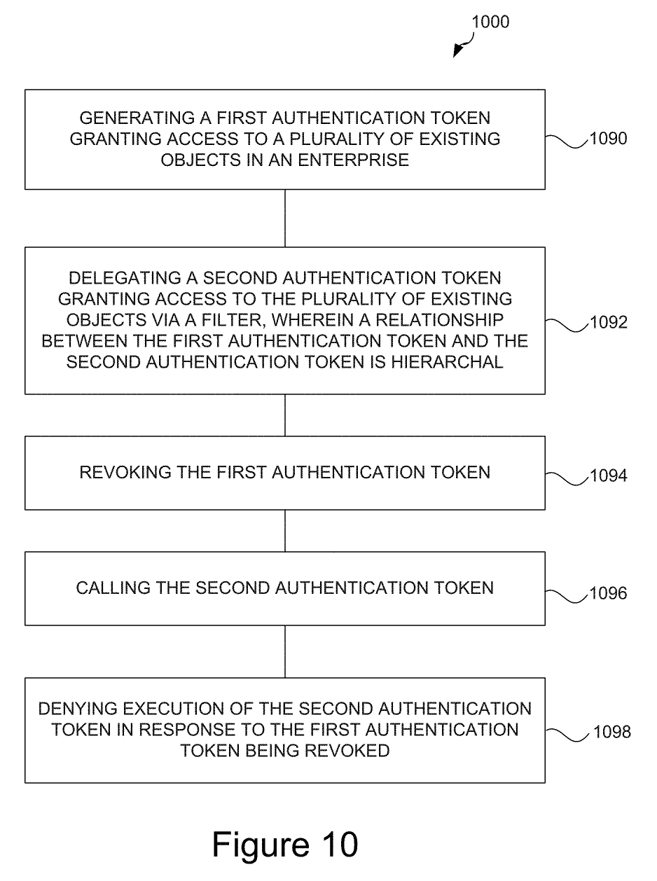

FIG. 10 illustrates a flow diagram for an example method for token delegation and revocation according to the present disclosure. In various examples, the method 1000 can be performed using the system 100 shown in FIG. 1 and/or the computing device and modules 201 shown in FIG. 2. Examples are not, however, limited to these example systems, devices, and/or modules.

At 1090, the method 1000 can include generating a first authorization token granting access to a plurality of objects in an enterprise. In some examples, the plurality of objects in the enterprise can be a plurality of existing objects. In addition, the enterprise can be an existing enterprise. Examples of objects can include a location in memory (e.g., a file, data structure, etc.). An existing object refers to an object that is generated prior to generation of a token (e.g., a first authorization token). Generating a first authorization token can include associating a secret with the first authorization token. For example, the token generation engine (106 illustrated in FIG. 1) can generate a first token having a first secret (e.g., 340 illustrated in FIG. 3). In some examples, generating a first authorization token can be executed using the engines in FIG. 1 and/or the computing device and modules in FIG. 2.

At 1092, the method 1000 can include delegating a second authorization token granting access to the plurality of objects via a filter, where a relationship between the first authorization token and the second authorization token can be hierarchal (e.g., the parent-child relationship illustrated at 430 in FIG. 4 and at 530 in FIG. 5). In various examples, as described above, constraining a second authorization token via a filter and relating the first and second tokens in a hierarchal fashion can be executed using the authorization engine 108 and/or the authorization module 208, illustrated in FIGS. 1 and 2.

At 1094, the method 1000 can include revoking the first authorization token. For example, as described above, a first authorization token can be revoked (e.g., at block 528 illustrated in FIG. 5). At 1096, the method 1000 can include calling the second authorization token. For example, as described above, a second authorization token can be called (e.g., at block 528 illustrated in FIG. 5). At 1098, the method 1000 can include denying execution of the second token in response to the first authorization token being revoked. For example, as described above, the delegation chain can be “walked” to ensure that a parent token has not been revoked at any point in the chain (e.g., at block 528 illustrated in FIG. 5). In some examples, the method 1000 can include verifying that the first authorization token is revoked prior to denying execution of the second authorization token.

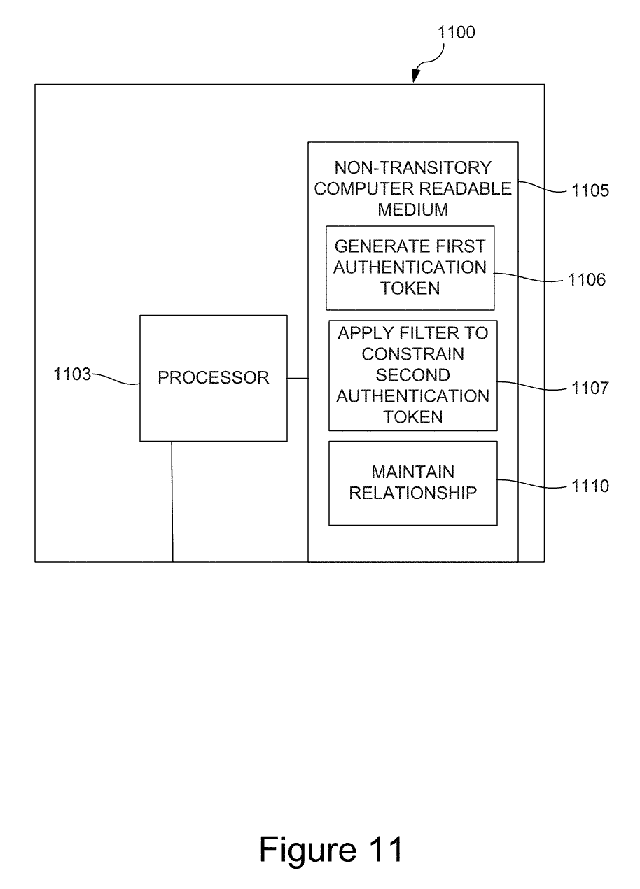

FIG. 11 illustrates a diagram of an example system 1100 including a processor 1103 and non-transitory computer readable medium 1105 according to the present disclosure. For example, the system 1100 may be an implementation of the example system of FIG. 1.

The processor 1103 may be configured to execute instructions stored on the non-transitory computer readable medium 1105. For example, the non-transitory computer readable medium 1105 may be any type of volatile or non-volatile memory or storage, such as random access memory (RAM), flash memory, read-only memory (ROM), storage volumes, a hard disk, or a combination thereof.

The example medium 1105 may store instructions 1106 executable by the processor 1103 to delegate fine-grained access authorization from a coarse-grained policy. For example, the processor 1103 may execute the instructions 1106 to generate a first authorization token that provides a first level of access to first data matching a first set of criteria. In addition, the processor 1103 can execute the instruction 1106 to perform block 1090 of the method of FIG. 10. As a further example, the instructions 1106 can be executable by the processor 1103 to generate a first authorization token. As a further example, the instructions 1106 can be executable by the processor 1103 to generate a token as described in connection with the token generation engine 106 of FIG. 1 and/or the token generation module 206 of FIG. 2.

The example medium 1105 may further store instructions 1107. The instructions 1107 can be executable to apply a filter to constrain a second authorization token that provides a second level of access to second data matching a second set of criteria. For example, the second authorization token and the first authorization token have a hierarchal relationship, the first level of access is greater than the second level of access, and the second set of criteria is a subset of the first set of criteria. In addition, the instructions 1107 can be executable by the processor 1103 to perform a portion of block 1092 of the method of FIG. 10.

The example medium 1105 may further store instructions 1110. The instructions 1110 can be executable to maintain the relationship between the first token and the second token. For example, instructions stored on the example medium 1105 can be executable by the processor 1103 to maintain the hierarchal relationship between the first authorization token and the second authorization token such that the second authorization token cannot interact with the first authorization token. In some examples, instructions stored on the example medium 1105 can be further executable maintain the relationship between the first and second authorization tokens such that if the first token is revoked, the second token is also revoked. For example, the instructions 1110 can be executable by the processor 1103 to perform a portion of block 1092 of the method of FIG. 10. As a further example, the instructions 1110 can be executable by the processor 1103 to maintain the relationship of the tokens as described in connection with the relationship engine 110 of FIG. 1 and/or the relationship module 210 of FIG. 2. In addition, the instructions stored on the example medium 1105 can be executed to associate and maintain a first secret with the first token and associate and maintain a second secret with the second token.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. For example, reference numeral 102 may refer to element “02” in FIG. 1 and an analogous element may be identified by reference numeral 203 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Further, as used herein, “a number of” an element and/or feature can refer to one or more of such elements and/or features.

As used herein, “logic” is an alternative or additional processing resource to perform a particular action and/or function, etc., described herein, which includes hardware, for example, various forms of transistor logic, application specific integrated circuits (ASICs), etc., as opposed to computer executable instructions, for example, software firmware, etc., stored in memory and executable by a processor.

What is claimed:

1. A non-transitory computer readable medium storing instructions executable by a processing resource to:
generate a first authorization token that provides a first level of access to first data matching a first set of criteria;
apply a filter to constrain a second authorization token that provides a second level of access to second data matching a second set of criteria, wherein the second authorization token and the first authorization token have a subset relationship, the first level of access is greater than the second level of access, and the second set of criteria is a subset of the first set of criteria; and
maintain the relationship between the first authorization token and the second authorization token.

2. The non-transitory medium of claim 1, wherein the instructions are further executable by the processor to
maintain the hierarchal relationship between the first authorization token and the second authorization token such that the second authorization token cannot interact with the first authorization token.

3. The non-transitory medium of claim 1, wherein the instructions are further executable by the processor to
maintain the relationship between the first and second authorization tokens such that if the first token is revoked, the second token is also revoked.

4. The non-transitory medium of claim 1, wherein the instructions are further executable by the processor to:
associate and maintain a first secret with the first token, and
associate and maintain a second secret with the second token.

5. A method of generating authorization tokens via filtering, comprising:
generating a first authorization token granting access to a plurality of existing objects in an enterprise;
delegating a second authorization token granting access to the plurality of existing objects via a filter, wherein a relationship between the first authorization token and the second authorization token is hierarchal;
revoking the first authorization token;
calling the second authorization token; and
denying execution of the second authorization token in response to the first authorization token being revoked.

6. The method of claim 5, further comprising verifying that the first authorization token is revoked prior to denying execution of the second authorization token.

7. The method of claim 5, wherein the plurality of objects in the enterprise are a plurality of existing objects in the enterprise.

8. The method of claim 5, further comprising:
associating a first secret with the first authorization token, and
associating a second secret with the second authorization token.

9. The method of 8, further comprising:
mapping the first secret to a first authorization policy, and
mapping the second secret to a second authorization policy via an authorization based access control authorization token store.

10. A system, comprising:
a token generation engine to:
generate a first authorization token having a respective first secret and granting full access to a plurality of existing objects in an existing enterprise, and
constrain a second authorization token having a respective second secret, wherein the second authorization token grants comparatively less access to the plurality of existing objects in the existing enterprise than the first authorization token;
an authorization engine to:
associate the first secret to a first authorization policy,
associate the second secret to a second authorization policy; and
a relationship engine to:
maintain a hierarchal relationship including a parent-child relationship between the first authorization token and the second authorization token.

11. The system of claim 10, wherein the parent-child relationship operates such that a child token is revoked in response to a parent token being revoked.

12. The system of 10, wherein generating the second authorization token comprises applying a filter to delegate the permissions associated with the second authorization token.

13. The system of claim 10, wherein the first secret and the second secret are different.

14. The system of claim 10, wherein the first secret and the second secret are maintained in an authorization based access control authorization token store.

15. The system of claim 10, wherein the enterprise system is an existing enterprise system.
